(19) United States
(12) Patent Application Publication
(10) Pub. No.: US 2012/0049425 A1
(43) Pub. Date: Mar. 1, 2012

(54) VIBRATION DAMPING AND ISOLATION MOUNTING DEVICE

(76) Inventor: John Willis, Virginia Beach, VA (US)

(21) Appl. No.: 12/964,873

(22) Filed: Dec. 10, 2010

Related U.S. Application Data
(60) Provisional application No. 61/377,974, filed on Aug. 29, 2010.

(51) Int. Cl. F16F 7/00

(52) U.S. Cl. 267/141

(57) ABSTRACT

An improved mounting device for physically connecting a device or electrical panel to a mounting structure, the improved mounting device providing improved shock and force isolation. The device comprises an inner and outer portion mechanically connected via flexible shock absorbing structures. The outer portion of the device mechanically connects to a mounting structure via removable connecting means. A device or electrical panel is attached via mounting means to the center portion of the invention. The device may further comprise a weather proof structure.

This application claims the benefit of U.S. Provisional Patent Application No. 61/377,974 filed on Aug. 29, 2010.

### BACKGROUND OF THE INVENTION

1. Field of the Invention

The present invention relates to a vibration absorbing device, and more particularly for a vibration absorbing device which is installed onto circuit boards or incorporated into mechanical structures for electrical and electronic systems and devices. More specifically, the field of the invention relates to devices which isolate electronic and other sensitive equipment and mechanical structures from forces related to vibration and physical impact.

2. Description of the Prior Art

Current devices which are intended to isolate electrical and mechanical structures from physical damage which results from vibrations (generally repetitive/cyclical movement) and short-term and/or instantaneous physical shocks and impacts fall into two general categories. First are those intended for large mechanical structures and which generally incorporate significant mechanical damping devices such as springs, large scale elastic structures, or gas/liquid hydraulic damping systems. Second are smaller-scale damping and shock absorbing devices which generally rely upon materials with elastic properties to isolate the device or equipment desired to be isolated from actual and/or potential vibrations and shock.

However, current designs leave some desirable solutions unresolved. First, current designs fail to incorporate modular design such that components may be easily removed, repaired and/or replaced. Second, current designs do not provide indicators for violations of design-limitations whereby a physical indicator notes vibration and shock forces that exceed the design limitations of a device or structure. Third, current designs are limited by the generally uni-dimensional design of shock absorbing members.

What is needed, therefore, is an improved vibration and shock isolation device that is modular in that it provides for permanent and/or semi-permanent physical mounting of the device intended to be isolated to the isolation device, but the isolation device is removably connected to the mounting structure (circuit boards, device frameworks, etc.).

### SUMMARY OF THE INVENTION

The present invention is a shock/vibration isolation device for mounting structures together, where the structures encounter vibrations, shock, and/or other physical stresses that may damage all or part of equipment desired to be isolated. In particular, the device is intended for the isolation mounting of predominantly flat panels including but not limited to industrial back-panels, printed circuit boards, automotive body panels, and the like. The device may further be utilized to mount mechanical or electrical/electronic devices to a structure. The current invention is comprised of an inner portion that comprises a device mounting hub, one or more outer portions comprising means to mount the device to a desired structure, and one or more flexible structures between the center mounting hub and the one or more mounting portions. The one or more outer mounting portions may be connected by and further comprising a ring structure such that the device comprises two concentric rings, connected by the one or more connecting structures between the concentric rings such that motion from the outer ring is attenuated prior to reaching the inner hub, thereby providing vibration and shock attenuation in three planes, protecting against movement from all possible directions.

The one or more outer mounting portions function to mechanically mount a panel or device to the shock/vibration isolation device. The center mounting hub may be constructed of material chosen from a group of flexible or semi-rigid material, and provides means to secure the shock/vibration isolation device to the desired installation point on the larger structure (the place where the panel and/or device desired to be isolated will be installed). In a preferred embodiment, the flexible structures are semi-rigid, and the flexibility of the flexible structures are chosen to be in accordance with the shock and vibration tolerances desired for a particular application. The flexible structures may be comprised of single strut portions, or the flexible structures may comprise interwoven portions that function to further attenuate motion of the mounting structure. Such interwoven portions may include but are not limited to a mesh, honeycomb, or netting-like structure; multiple or individual strands of simple or complex geometry; an inner tube (or partial tube) of solid or hollow material which may be filled with a gas, liquid, solid, or visco-elastic polymer; rubber bands or strands; or virtually any other method to provide flexibility between the inner hub and outer ring. The inner hub, flexible structure, and outer ring can be fabricated as a single monolithic structure or multiple structures assembled together to form the complete unit. In each embodiment of the invention, the flexible structures may be constructed such that vibrations and/or shocks are attenuated in particular directions of motion, and may (such as in the example of utilizing a curved “wave” design) attenuate motion in all directions relative to the device and/or panel sought to be isolated from such forces. The invention as disclosed herein may be used to mount items such as industrial back-panels, printed circuit boards, automotive panels, and the like.

In order to facilitate installation, a mounting hole is preferentially provided within the subject panel. The outer ring of the shock/vibration isolation device fits inside this mounting hole. A wider flange around the top of the outside of the outer ring rests against the top of the subject panel and prevents the device from sliding all the way through the mounting hole. Single or multiple mounting tabs flex inward as the device is pushed through the mounting hole and, once the device has been fully inserted into the mounting hole, the tabs expand back to their normal position and due to the tab geometry, prevent the device from pushing back out of the mounting hole. The outer ring is designed such that secure mounting is achieved without mechanical strain on the mounting structure. The mounting hole preferentially is slightly larger than the outer ring, and the thickness of the device panel is preferentially slightly thinner than the distance between the mounting tabs and the flange on the outer ring; for this reason, the shock/vibration device does not exert forces on the mounting hole prior to the inner hub being secured to the mounted structure.

Installation proceeds in the following manner: the outer ring is attached first into the support structure, whether it be a panel or other structural member; then the inner hub mounting portion is fastened to the device panel or device with a fastener. The fastening hardware should not impinge upon the range of motion allowed by the flexible structure; there will be no snubbing action or range of motion limitations other than those provided by the flexible structure. The fastening hardware may comprise of a bolt and associated threaded center portion to the mounting portion of the inner hub, quick release fasteners, or any other means commonly utilized to fasten components to structural members in a subject device. It will be understood that the fastening hardware may be chosen for properties in addition to fastening one structure to another, such as choosing fastening hardware that is electrically insulating.

In another embodiment of the present invention, the device further comprises a clamping portion, such that the device panel sought to be mounted to the main structure may be clamped in place without the need to secure the device panel through holes or other means that may compromise the integrity of the device panel. The clamping portion further allows the present invention to be utilized with existing device panels without requiring the modification of the device panel.

Accordingly, it is an object of the present invention to provide an improved shock/vibration isolation device.

It is also an object of the present invention to provide an improved shock/vibration isolation device that incorporates improved isolation/absorption designs for the flexible structures connecting the device desired to be protected to the mechanical mounting structure. These flexible structures can be engineered with varying rigidities and densities to compensate for predominately vertical or horizontal mounting as dictated by the application.

It is yet another object of the present invention to provide an improved shock/vibration isolation device that incorporates mechanical fusing into shock/vibration isolation structures, the mechanical fusing providing mechanical indication of exposure to forces exceeding the design limits of the specific isolated device.

It is yet another object of the present invention to provide a shock/vibration isolation mounting system whereby component structures and panels may be attached and removed as needed without removal and/or repair of the whole of the subject isolated device.

It is yet another object of the present invention to provide a shock/vibration isolation mounting system whereby the center hub of the mounting structure has a stand-off already incorporated into the structure. This stand-off may have expanded sides at the base to allow for exceptional stability. This wider base may be used without a fastener and use adhesive alone as a mounting method.

It is yet another object of the present invention to provide a shock/vibration isolation mounting system whereby the center hub of the mounting structure has a fastener already incorporated into the structure.

It is yet another object of the present invention to provide a shock/vibration isolation mounting system whereby the built-in fastener already has a glue or thread-locking compound pre-installed on the fastener such that installation of the fastener activates the glue or thread-locking compound

### DESCRIPTION OF THE DRAWINGS

FIG. 1 is a view of an embodiment of the present invention utilizing wave connecting portions.

FIG. 2 is a view of an embodiment of the present invention comprising a plurality of overlapping connecting portions.

FIG. 3 is a view of an embodiment of the present invention comprising a coiled spring connecting portion.

FIG. 4 is a view of an embodiment of the present invention comprising a tube connecting portion.

FIG. 5 is a view of an embodiment of the present invention comprising a plurality of arched connecting portions.

FIG. 6 is a view of an embodiment of the present invention comprising a plurality of isolated connecting portions, each connecting portion terminating in a mounting portion.

FIG. 7 is a view of an embodiment of the present invention, further comprising a clamp portion for grasping device panels.

FIG. 8 is a view of an embodiment of the present invention, further comprising a weather proof enclosure.

### DESCRIPTION OF A PREFERRED EMBODIMENT

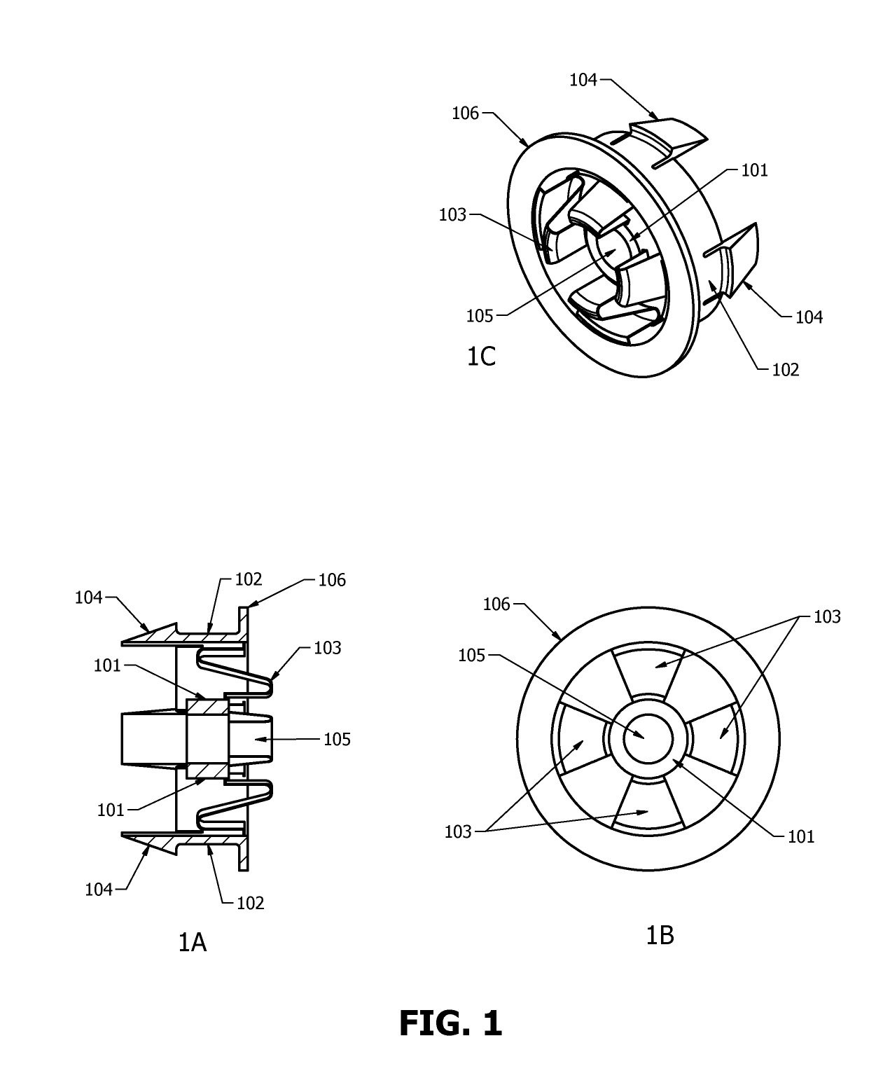

1. Referring now to FIG. 1, an embodiment of the current invention is shown with an inner portion 101, and outer portion 102 comprising a ring structure, concentric with the inner portion 101 with further comprises with mounting means 105. The inner portion 101 and the outer portion 102 are mechanically connected via one or more flexible members 103. The outer portion further comprises mounting means 104, which, when the device is attached to a support structure, operate to hold the device in place. There is a flange portion 106 located on the outer portion 102 and distal to the mounting means 104. FIG. 1A shows a side view of the present invention, FIG. 1B shows a top view, and FIG. 1C shows a perspective view of the device.

The one or more flexible members 103 may move vertically and horizontally relative to the horizontal plane of the device, as well as in a combination of motions comprised of the sum of motions about the center axis of the device. The one or more flexible members 103 may be constructed of materials chosen from a group providing mechanical fusing means, such that forces exceeding desired limits or motions exceeding desired physical movement limits will cause the one or more flexible members 103 to break. The mounting means 104 are compressible such that the inner portion can be inserted into a mounting hole in a panel; the mounting hole is slightly larger than the outer portion but smaller than the diameter of the flange 106 and the mounting means 104.

The thickness of a panel is thinner than the distance between the mounting means 104 and the flange 106, such that the shock/vibration device does not exert forces on the mounting hole prior to the inner hub being secured to the mounting structure. Installation shall be such that the outer ring is snapped into the mounting hole on the subject panel, followed by securing the inner hub to the mounted structure with a fastener. The fastening hardware should not impinge upon the range of motion allowed by the flexible structure; there will be no snubbing action or range of motion limitations other than those provided by the flexible structure.

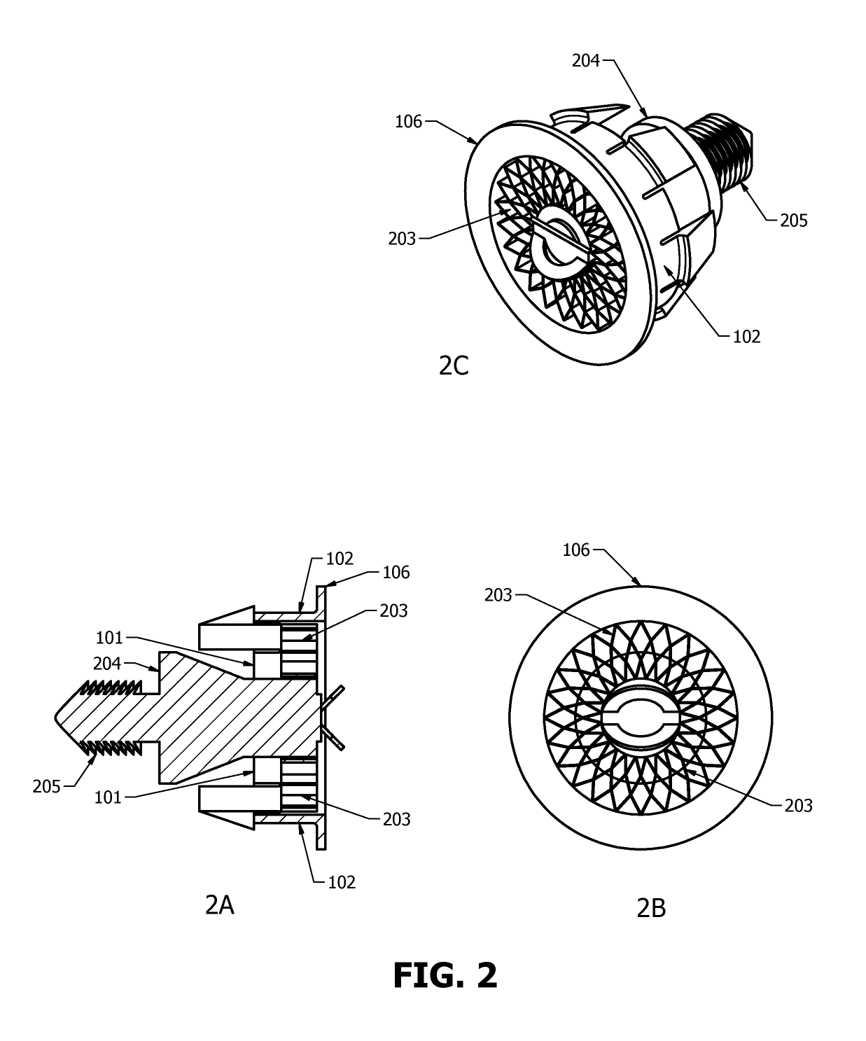

Referring now to FIG. 2, as with FIG. 1, a side view FIG. 2A, a top view FIG. 2B, and a perspective view FIG. 2C of an embodiment of the present invention are shown. The one or more flexible members 203 connecting the inner portion 101 and the outer portion 102 comprise a plurality of overlapping members in the manner shown. The connecting portion 204 comprises a stem and connecting means 205.

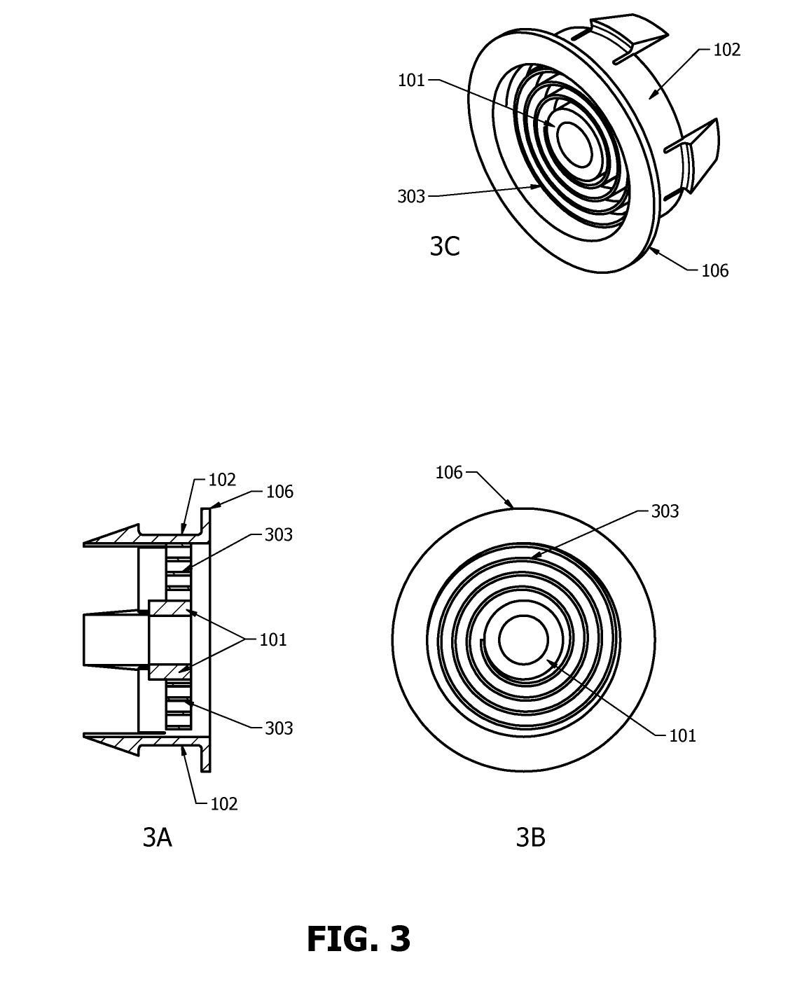

Referring now to FIG. 3, a side view FIG. 3A, a top view FIG. 3B, and a perspective view FIG. 3C of an embodiment of the present invention are shown. The one or more flexible members 303 connecting the inner portion 101 and the outer portion 102 comprises a coil spring member in the manner shown.

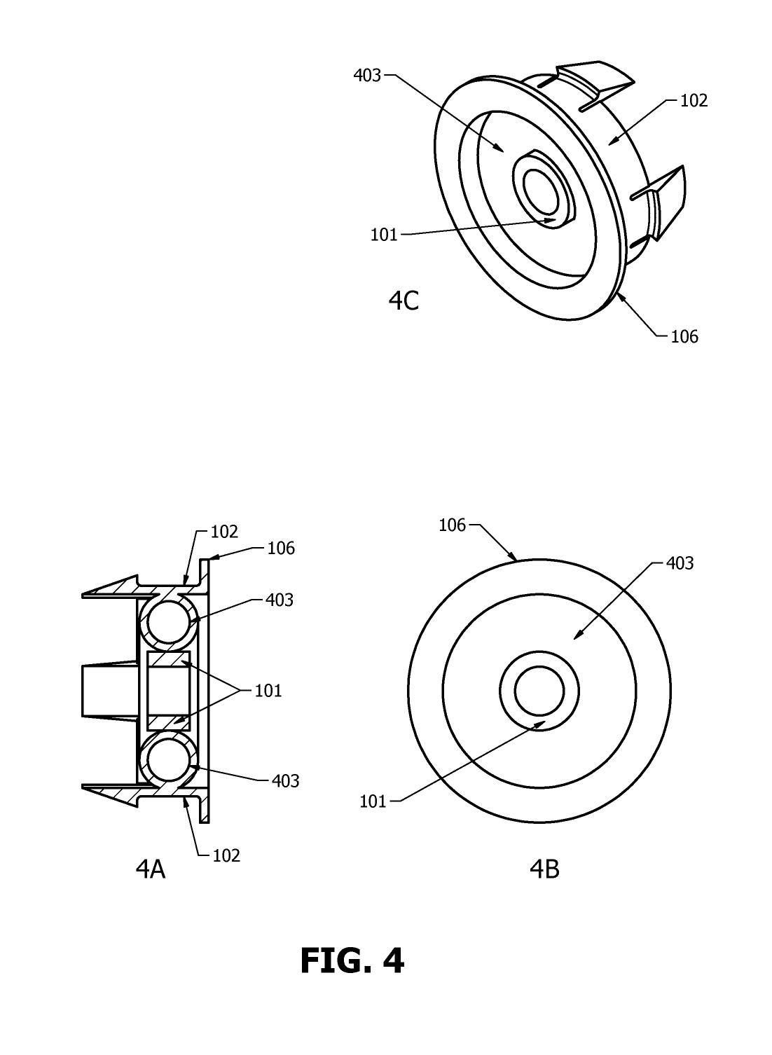

Referring now to FIG. 4, a side view FIG. 4A, a top view FIG. 4B, and a perspective view FIG. 4C of an embodiment of the present invention are shown. The one or more flexible members 403 connecting the inner portion 101 and the outer portion 102 comprises a tubular member in the manner shown. The flexible member 403 may comprise a closed tube of flexible material such as rubber or plastic, and may be filled with gas or liquid to assist in the attenuation of physical forces on the device as a result of vibration or shock.

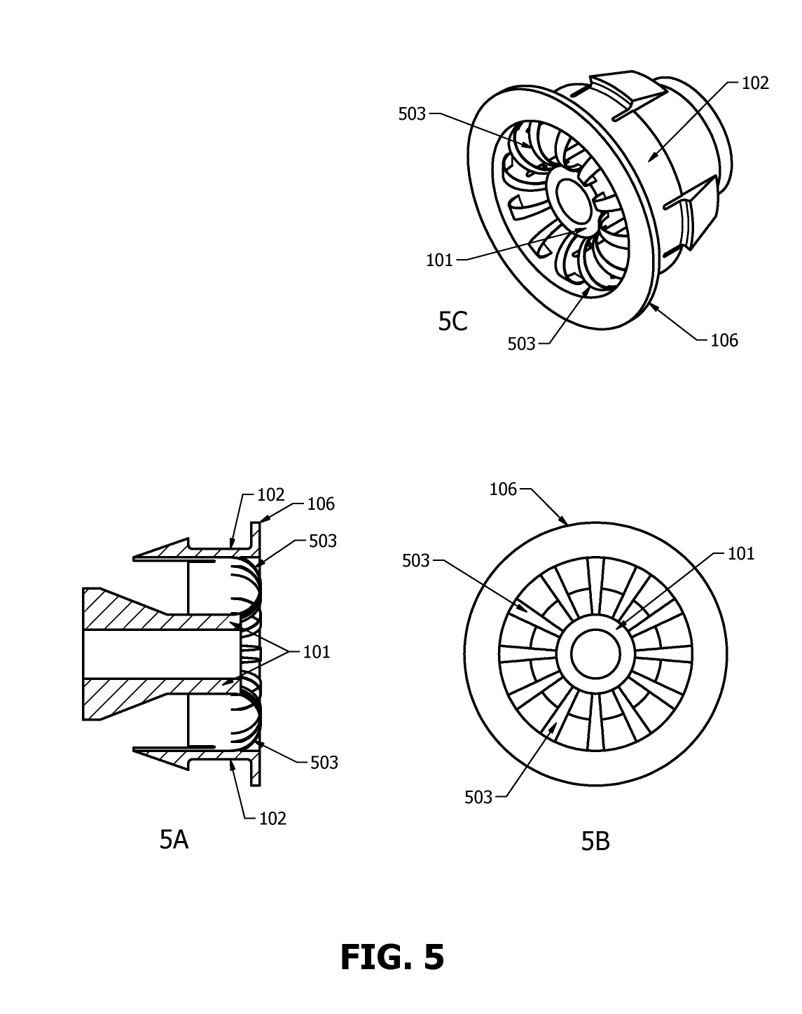

Referring now to FIG. 5, a side view FIG. 5A, a top view FIG. 5B, and a perspective view FIG. 5C of an embodiment of the present invention are shown. The one or more flexible members 503 connecting the inner portion 101 and the outer portion 102 comprise a plurality of arched members in the manner shown.

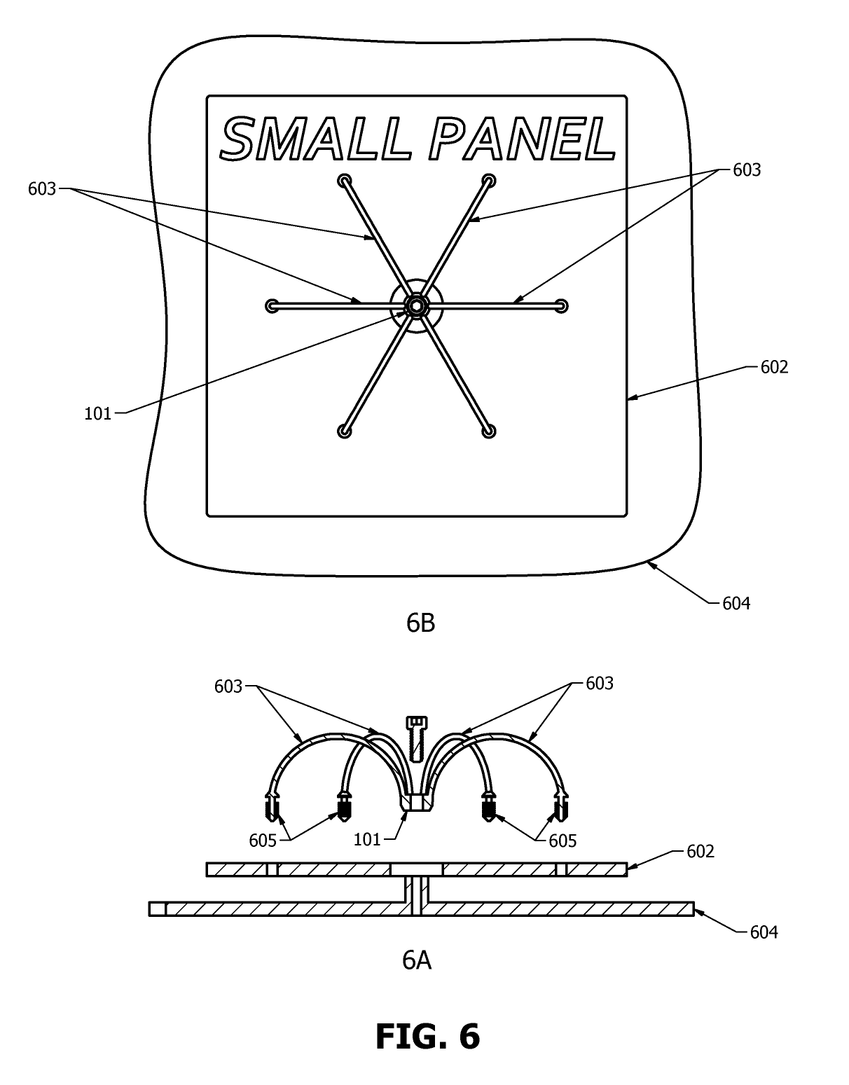

Referring now to FIG. 6, a side view FIG. 6A, and a top view FIG. 6B of an embodiment of the present invention are shown. The plurality of flexible members 603 connect the inner portion 101 with a plurality of connecting portions 605, each flexible member 603 terminating in a connecting portion 605. The one or more flexible portions move independently of each other. It will be understood that there may be two or more flexible portions 605, and the number chosen may vary depending upon the application. The device is shown in FIG. 6B as connected to a device panel 602, and a structural member 604.

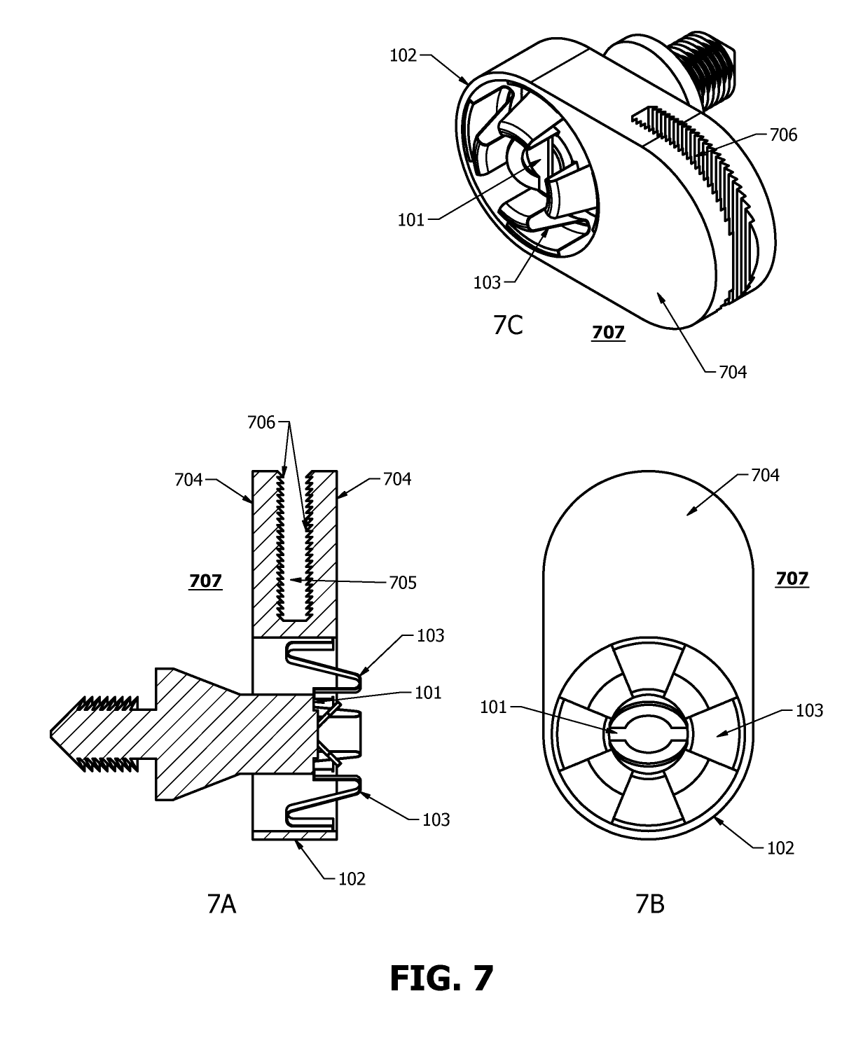

Referring now to FIG. 7, a side view FIG. 7A, a top view FIG. 7B, and a perspective view FIG. 7C of an embodiment of the present invention are shown. The one or more flexible members 103 connecting the inner portion 101 and the outer portion 102 are as shown in FIG. 1. The device as shown in FIG. 7 further comprises a clamping portion 707. The clamping portion 707 comprises parallel members 704 with a clamping space 705 defined by the parallel members 704. The parallel members 704 further comprise mechanical restraining means 706, which assist in gripping a subject panel to the device.

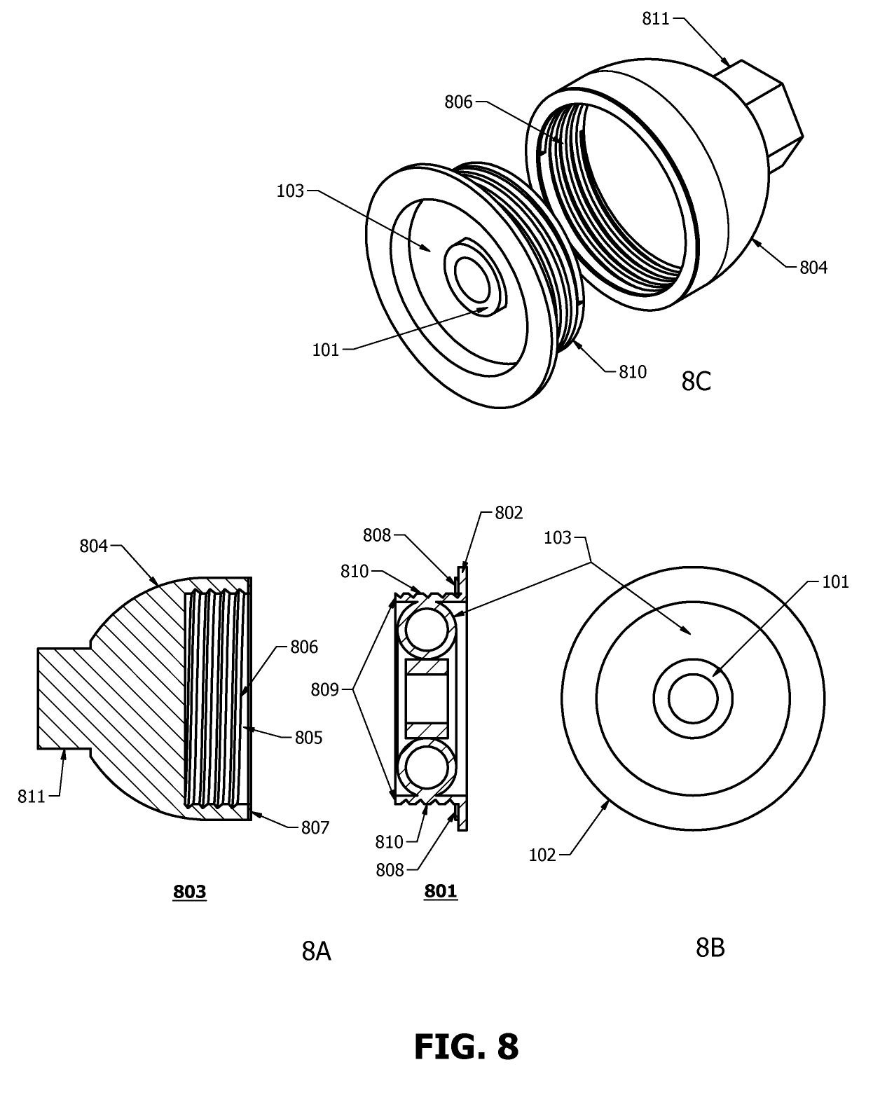

Referring now to FIG. 8, a view of an embodiment of the present invention showing a shock mount 801 that further comprises a weather proof cover 803 is shown. As before, the inner portion 101 and the outer portion 102 are connected by one or more flexible members 103. The outer portion 102 further comprises a gasket base portion 802, a first ring gasket 808, and a threaded collar 809. The weather proof cover 803 comprises a sealed dome portion 804, a recess 805, threads 806 that correspond in size and number to the threads 810 on the threaded collar 809, and a second ring gasket 807. The recess 805 has an interior diameter such that the threaded collar 809 can be screwed into the recess. While the shock mount 801 is connected to the weather proof cover 803, the shock mount 801 and the equipment that it is attached to is sealed against weather and other environmental conditions. It will be understood that the materials for the first ring gasket 808, the second ring gasket 807, the weather proof cover 803 and the shock mount 801 may be chosen from a group of materials that provide protection from various environmental conditions, including water and other liquids such as hydrocarbons and/or corrosive liquids, gases such as explosive gases, dust or corrosive solids, gels, or any other environmental condition from which it is desirable to isolate the shock mount and associated equipment. Therefore, the term “weather proof” in this context should be understood to refer to a structure that will seal the shock mount 801 from the surrounding or outside environment. The weather proof cover 803 may further comprise a projection 811 where the projection provides a shape conducive to allowing the use of tools to assist in tightening the weather proof cover 803 onto the shock mount 801. While the invention as shown displays a common hexagonal nut pattern for the projection 811, it will be understood that the projection 811 may be fashioned in such a manner that various common tools or specialized tools may be used to screw the weather proof cover 803 onto the shock mount 801. For example, the shape may accommodate any size of standard or metric wrench or socket, it may be fashioned such that a screwdriver (flat head, philips head, star, or other shape), alien wrench, or other tool may fit into the projection 811 to assist a user in screwing the weather proof cover 803 onto the shock mount. It will be understood that the term “tool” is not meant to be limiting in any fashion therefore.

It will be understood that the one or more flexible members as shown in FIGS. 1-8 may be constructed of materials chosen to serve as mechanical fuses, the mechanical fusing providing failure of the flexible members when exposed to predetermined mechanical movement or stress. The use of specific mechanical fusing tolerances can serve two or more purposes. First, the failure of the mechanically fused structure, resulting in the mechanical disconnection of the inner and outer portion of the device, serves to protect either the panel and associated materials/constructions from overstressing and/or the structure to which the panel is mounted, in the event of excessive mechanical strain. Secondly, the mechanical fusing will provide an indicator that a device or structure has been subjected to tolerances outside of the normal ranges of tolerances for use of a particular device or structure, which in turn provides an indication whether or not a failure is due to manufacturing or design flaws or is due to excessive environmental forces for which the device is not designed.

It will be further understood that the flexible members may be constructed of materials chosen from a group of flexible materials including metals, plastics, and other semi-rigid materials. The use of any particular material that provides the same mechanical properties as described herein will not deviate from the spirit and the scope of the present invention. It will also be understood that the inner hub, flexible structure, and outer ring can be fabricated as a single monolithic structure or multiple structures assembled together to form the complete unit.

When mounted within a hole in a panel, the present invention may further comprise a locking pin or mechanism that mechanically restrains the device from rotating within the mounting hole, the locking means being a pin and recess or other means well known in the art. In this manner, the invention provides both torsional attenuation about the vertical axis of the device, and also may be designed such that the locking means provides mechanical fusion for torsional strain.

It will also be understood that the means for fastening the present invention to a panel may be a push-in fastener, in which case a foldable, pull-out tab is recommended. A push-in fastener, depending on the installation environment, promotes a single, push-in, installation procedure for panel mounting wherein a single action installs the shock/vibration isolation device to the subject panel and to the mounted surface. The present invention may also incorporate a glue or thread-locking compound that has been pre-installed on the fastener such that installation of the fastener activates the glue or thread-locking compound. The flexible structure connecting the inner and outer portion may also be asymmetric, providing more attenuation in some directions as compared to others; such design allows for modification for specific applications, such as in high-stress applications where forces are significantly greater in some directions that in others, in cases where the invention is used to mount vertically rather than horizontally, and the like.

The present invention is also intended to be used in a manner that does not require the use of one or more mounting holes in the subject panel. In such a configuration, the device includes clamps which grasp the edges or corners of a panel, securing the device in place without the need for holes through the panel. This embodiment can be configured to slide over small abnormalities in the printed circuit board. This embodiment will also allow for installation using a printed-circuit-board-compatible glue as a complimentary means of holding the push-clamp in place. It will also be understood that the inner and outer portions, although described herein as generally circular, may be of any shape to accommodate particular needs without deviating from the scope of the invention.

The invention herein has been described in detail, and in light of the FIGS. 1-8. It will be understood, however, that the description herein is not intended to be limiting, and variations in materials and configuration of the invention may be made without exceeding the scope of the invention.

What is claimed is:

1. A shock/vibration isolation device for mechanically mounting panels to structures, the device comprising an inner portion which is a center mounting hub, an outer portion, and a flexible structure between the inner portion and the outer portion that mechanically connects the inner portion and the outer portion such that motion from the outer portion is attenuated prior to reaching the inner portion.

2. The shock/vibration isolation device of claim 1 wherein the said outer portion is an annular structure.

3. The device of claim 1 wherein the shock/vibration isolation device attenuates motion between the outer portion and the inner portion in all three possible planes of motion.

4. The device of claim 2 wherein the said outer portion is comprised of semi-rigid material, and further comprises means to secure the shock/vibration isolation device to a panel, and the panel further comprises a hole or other corresponding form or structure into which the means to the secure the said panel is secured.

5. The device of claim 2 wherein the inner ring is comprised of a semi-rigid material and further comprises means to secure the shock/vibration isolation device to a structure.

6. The device of claim 2 wherein the flexible structure is comprised of one or more members, the number of members chosen based upon a desired application.

7. The device of claim 6 wherein the one or more members comprise a geometric structure chosen from the group comprising a mesh, honeycomb, or netting-like structure of multiple or individual strands of simple or complex geometry

8. The device of claim 7 wherein the one or more members is a partial or complete tube of solid or hollow material.

9. The device of claim 7 wherein the one or more members is formed from a material chosen from the group comprising visco-elastic polymer, rubber or other flexible material.

10. The device of claim 8 wherein the one or more members is hollow tube and is filled with a vacuum, a gas, liquid, or a solid.

11. The device of claim 2, wherein the said panel further comprises a mounting hole, the mounting hole corresponding in size to the outer ring of the shock/vibration isolation device such that that outer ring of the shock/vibration isolation device is insertable inside the mounting hole.

12. The device of claim 11 wherein the outer portion further comprises a flange and one or more mounting tabs, the one or more mounting tabs being flexible such that the mounting tabs compress inward towards the central vertical axis of the shock/vibration isolation device as the shock/vibration isolation device is inserted through a mounting hole in a panel, the tabs expanding outwards back to their normal position once the shock/vibration isolation device is located within a hole in a panel, the mounting tabs expanding to a circumference larger than the circumference of the mounting hole, thereby restraining the shock/vibration isolation device within the mounting hole.

13. The device of claim 11 wherein the outer portion comprises a threaded center portion and a corresponding threaded nut to be secured onto the threaded center portion once the threaded center portion is inserted through the mounting hole in the panel.

14. The device of claim 12 wherein the flange positioned around the top of the outside of the outer ring rests against the side of the panel opposite the side proximal to the mounting tabs, thereby preventing the device from sliding all the way through the mounting hole.

15. The device of claim 14, wherein the portion of the shock/vibration isolation device located within the mounting hole in the panel exerts no pressure on the panel within the mounting hole other than that provided by gravity.

16. The device of claim 1 wherein the shock/isolation device is connected to the said panel at a predominantly flat portion of the said panel.

17. The device of claim 1 wherein the said panel may be an industrial back-panel, a printed circuit board, or an automotive panel.

18. The device of claim 1 wherein the shock/vibration isolation device comprises a mechanical fuse.

19. The device of claim 14, further comprising mechanical restraining means such that the shock/vibration isolation device is prevented from rotating with the mounting hole, thereby attenuating torsional strain.

20. The device of claim 19 wherein the mechanical restraining means provides mechanical fusing for torsional mechanical overload.

21. The shock/vibration isolation device of claim 1 wherein the outer portion is comprised of a plurality of mounting structures, the mounting structures flexibly connected to the inner portion by connecting means, and the mounting structures comprising fastening means to mechanically attach the shock/vibration isolation device to a panel, the panel comprising means for accepting and mechanically holding the mounting structures of the device.

22. The shock/vibration isolation device of claim 21 wherein the device is asymmetrical about the vertical axis of the central portion.

23. The shock/vibration isolation device of claim 21 wherein the device is symmetrical about the vertical axis of the central portion.

24. The shock/vibration isolation device of claim 21 wherein the fastening means is chosen from the group comprising built-in, push-in fasteners with built-in, push-through limits.

25. The shock/vibration isolation device of claim 1 wherein the center portion further comprises a stand-off.

26. The shock/vibration isolation device of claim 1 wherein the flexible structure is asymmetric.

27. The shock/vibration isolation device of claim 1 further comprising means for clamping the device to the edge of a panel.

28. The device of claim 1 further comprising means for covering the portion of the shock/vibration isolation device that is inserted through a mounting hole in a panel, and the means for covering seals in whole or in part the mounting hole and the device from environmental conditions.

29. The shock/vibration isolation device of claim 1 further comprising a threaded collar portion which may be screwed into a weather proof cover, the weather proof cover and the shock/vibration isolation device having ring gaskets to seal the shock/vibration isolation device and the weather proof cover against environmental conditions.

30. The shock/vibration isolation device of claim 29 wherein the environmental conditions may be liquid, solid, gas or any other materials.

31. The shock/vibration isolation device of claim 29 wherein the weather proof cover further comprises means to accommodate a tool.
